(19) United States
(12) Patent Application Publication
(10) Pub. No.: US 2013/0020350 A1
(43) Pub. Date: Jan. 24, 2013

(54) METHOD OF DISPENSING PESTICIDAL BAIT AND ELECTRICALLY POWERED DISPENSING DEVICE

(71) Applicants: Mclaughlin Gormley King Company, Minneapolis, MN (US); Stainless Steel Coatings, Inc., South Lancaster, MA (US)

(72) Inventors: Ivan Gardos, Calgary (CA); Robert Suranyi, Minneapolis, MN (US)

(73) Assignees: STAINLESS STEEL COATINGS, INC., South Lancaster, MA (US); MCLAUGHLIN GORMLEY KING COMPANY, Minneapolis, MN (US)

(21) Appl. No.: 13/628,501

(22) Filed: Sep. 27, 2012

Related U.S. Application Data
(63) Continuation of application No. 13/420,114, filed on Mar. 14, 2012.
Application No. 13/420,114 is a continuation of application No. 13/223,572, filed on Sep. 1, 2011, now abandoned.
(60) Provisional application No. 61/379,090, filed on Sep. 1, 2010.

(51) Int. Cl. A01M 7/00; B65D 88/54; G01F 11/00; B65D 5/66

(52) U.S. Cl. 222/1; 222/326; 222/23; 222/66; 222/55; 222/113; 222/14; 222/333; 222/390

(57) ABSTRACT

A method of dispensing a pesticidal bait with an electrically powered dispensing device is provided. A fluid dispensing device and system provides the user the ability to deposit controlled and precise amounts of a substance in specific target areas with capacity to record and transfer the information for diverse user defined purposes. The substance dispensed by the device can easily be deposited into desired locations. Viewing of the dispensed material and its location is enhanced with the aid of a light source if there is not sufficient light available to see adequately.

This application is a continuation of U.S. Ser. No. 13/420,114, filed Mar. 14, 2012, which is a continuation of U.S. Ser. No. 13/223,572, filed Sep. 1, 2011, now abandoned, which claims the benefit of U.S. Provisional Patent Application No. 61/379,090, filed Sep. 1, 2010, entitled “Method of Dispensing Pesticidal Bait and Electrically Powered Dispensing Device”, the contents of each of which are hereby incorporated by reference herein.

### FIELD OF THE INVENTION

The present invention relates to a method of dispensing a pesticidal bait with an electrically powered dispensing device. This method provides for the controlled and precise dispensing of pesticidal bait from cartridges or syringes and the like. The dispensing of the bait can be automatically or manually controlled to deliver an amount of material as necessary. The invention also relates to the electrically powered dispensing device and methods of using it to dispense fluids.

### BACKGROUND OF THE INVENTION

Previous methods for dispensing pesticidal baits used purely mechanical dispensers. Such commercially available dispensers, however, are of limited use when trying to reach difficult areas, when a specific and precise amount of fluid is needed for dispensing, or when the application area cannot be seen adequately.

Difficulty exists in current fluid dispensing systems to safely deposit a controlled and precise amount of pesticide in exactly the proper location. Some pesticides require very small amounts to be applied and excess fluid application can be wasteful and expensive. In addition, excess pesticides can remain in sensitive areas and create potential exposure hazards. Additional problems arise when material continues to be dispensed from the device after pressure applied to the trigger has been stopped, or when too much pressure is applied to the trigger and fluid dispensing is uncontrollable.

The device herein disclosed provides a dispensing system which allows the user to dispense a precisely controlled amount of pesticide or other substances. The material application ceases immediately no matter the pressure applied to the trigger, when the predetermined amount of substance has been applied. The fluid dispensing system has many safeguards available to ensure proper delivery of the controlled material and allows the selection and delivery of varying amounts of materials. The device is capable of monitoring and recording the amount dispensed allowing users to utilize the data as needed (regulatory, monitoring, quality assurance, etc. purposes). The device can provide work area illumination.

### SUMMARY OF THE INVENTION

The present invention provides for dispensing of a pesticidal bait with an electrically powered dispensing device. A fluid dispensing device and system provides the user the ability to deposit controlled and precise amounts of a substance in specific target areas with capacity to record and transfer the information for diverse user defined purposes. The substance dispensed by the device can easily be deposited into desired locations. Viewing of the dispensed material and its location is enhanced with the aid of a light source if there is not sufficient light available to see adequately.

The present invention also provides for a method of dispensing a pesticidal bait by providing an electrically powered dispensing device having a dispensing mechanism for the dispensing of the pesticidal bait and a mechanism control for controlling the dispensing of the pesticidal bait. The method further includes loading a cartridge chamber or syringe containing pesticidal bait into the electrically powered dispensing device and dispensing the pesticidal bait from the electrically powered dispensing device by applying pressure on a trigger on the electrically powered dispensing device in communication with the dispensing mechanism and the mechanism control.

The mechanism control of the method of the present invention may allow a controlled volumetric flow rate of pesticidal bait to be dispensed by the dispensing mechanism and additionally may allow a controlled volume of pesticidal bait to be dispersed by the dispensing mechanism. Further the mechanism control of the method of the present invention may have an optical feedback system that monitors the volume and volumetric flow rate of pesticidal bait in the cartridge chamber and may halt dispensing of the pesticidal bait when an insufficient volume is detected in the cartridge chamber or syringe and additionally may halt dispensing of the pesticidal bait and release pressure build-up in the cartridge chamber or syringe when a desired volume of pesticidal bait in the cartridge chamber has been dispensed at a desired volumetric rate of flow. The optical feedback system may further have an optical sensor that is coupled to the dispensing mechanism of the present invention.

The electrically powered dispensing device of the method of the present invention may also be provided with a light source and may have a user input control having an information display and manual controls for data entry.

The pesticidal bait of the method of the present invention may be in gel form and may be a knockdown agent, toxicant, synergist, or insect growth regulator.

The present invention also provides for an electrically powered dispensing device for dispensing a pesticidal bait having a housing and a dispensing mechanism for the dispensing of the pesticidal bait with a motor coupled to a shaft in communication with a gear train, the gear train driving a lead screw and drive nut that extends and retracts a plunger. The electrically powered dispensing device also has a mechanism control for controlling the dispensing of the pesticidal bait; a cartridge chamber or syringe containing pesticidal bait; and a trigger in communication with the dispensing mechanism and the mechanism control.

The mechanism control of the electrically powered dispensing device of the present invention may allow a controlled volumetric flow rate of pesticidal bait to be dispensed by the dispensing mechanism and additionally may allow a controlled volume of pesticidal bait to be dispersed by the dispensing mechanism. Further the mechanism control of the electrically powered dispensing device of the present invention may have an optical feedback system that monitors the volume and/or the volumetric flow rate of the pesticidal bait in the cartridge chamber and may halt dispensing of the pesticidal bait when an insufficient volume is detected in the cartridge chamber or syringe and additionally may halt dispensing of the pesticidal bait and release pressure build-up in the cartridge chamber or syringe when a desired volume of pesticidal bait in the cartridge chamber has been dispensed. The optical feedback system of the mechanism control may further have an optical sensor coupled to the dispensing mechanism of the present invention.

The electrically powered dispensing device of the present invention may also be provided with a light source and may have a user input control having an information display and manual controls for data entry.

The pesticidal bait of the electrically powered dispensing device of the present invention may be in gel form and may be a knockdown agent, toxicant, synergist, or insect growth regulator.

### BRIEF DESCRIPTION OF THE DRAWINGS

A preferred form of the dispenser of the invention will now be described by way of example with reference to the accompanying drawings.

FIG. 1 illustrates a side view of a fluid dispenser of the present invention.

FIG. 2 illustrates a perspective view of the interior cavities of a fluid dispenser of FIG. 1.

FIG. 3 illustrates a disassembled view of the dispensing mechanism of the dispenser of FIG. 1.

FIG. 4 illustrates a flow chart of the hardware and software system of the dispenser of FIG. 1.

FIG. 5 illustrates a perspective view of an alternative fluid dispenser of the present invention.

### DETAILED DESCRIPTION OF THE PREFERRED EMBODIMENTS

The invention provides a method of dispensing a pesticidal bait with an electrically powered dispensing device. In one embodiment, the dispensing device is hand-held. In another embodiment, the pesticidal bait is dispensed from a syringe, preferably smaller than 100 cc and more preferably smaller than 50 cc. In a preferred embodiment, the syringe is 30 cc. The pesticidal bait can be used to target any pests with pesticides formulated into a syringe-type delivery systems, including but not limited to cockroaches, ants, and stinging arthropods. In addition, the invention is suitable to dispense semiochemicals and other pest management materials which require the introduction of a controlled amount of pesticide into sensitive areas. This invention can also be utilized in weed control by applying herbicides into individual target areas in sensitive environments where any drift can be detrimental, including but not limited to home gardens, indoor environments, quarantine treatments, etc.

Any known pesticide may be used in the invention. The pesticide is applied in fluid form, preferably, but not limited to, a gel. The pesticide may be selected from knockdown agents, toxicants, synergists, and insect growth regulators. The pesticide may comprise, but is not limited to, one or more of the following: pyrethrins, prallethrin, imipothrin, d-trans allethrin, esbiol, esbiothrin, tetramethrin, pynamin forte, permethrin, cypermethrin, lambda-cyhalothrin, cyfluthrin, d-phenothrin, esfenvalerate, bifenthrin, piperonyl butoxide, n-octyl bicycloheptene dicarboximide, pyriproxyfen, methoprene, imidacloprid, abamectin, and isomers thereof.

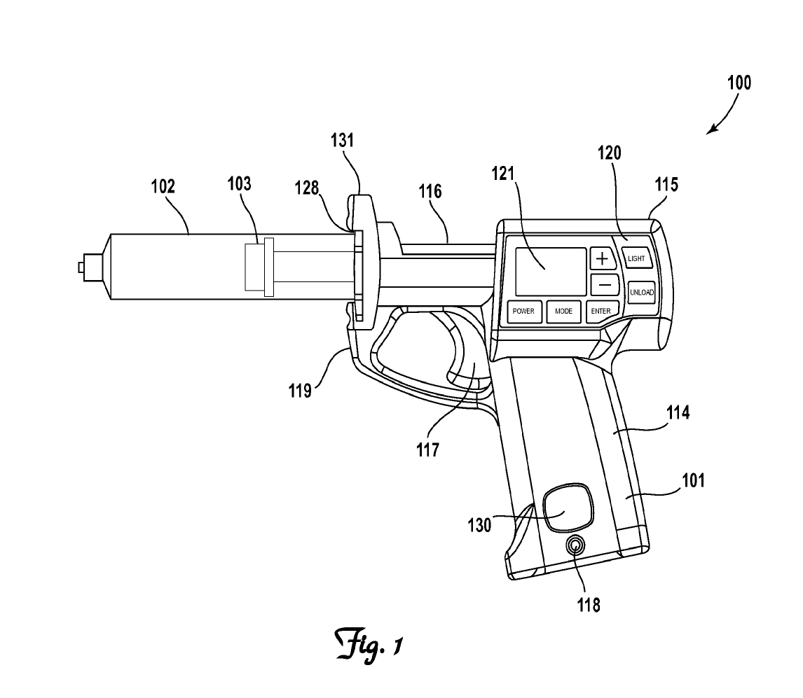

A preferred dispensing device is described below. FIG. 1 illustrates fluid dispenser 100 and includes a pistol-shaped housing 101, which may be made from glass filled polycarbonate, with handle 114, a body 115, a drive enclosure 116 and a removable cartridge chamber or syringe 102 mounted in slot 128 of snout 131. The removable cartridge or syringe 102 extends longitudinally outward from the drive enclosure 116. Trigger 117 is located along the forward side of handle 114 and body 115. Handle 114 additionally contains a removable battery pack with a charger status LED light 118 and battery pack release button 130. A work area illuminating LED light 119 may be located directly below the cartridge chamber and gives the operator better visual illumination of the dispensing area for more optimum placement of material. The design and position of the illuminating LED light 119 is not limiting and is reconfigurable to accommodate specific market requirements in which the invention can be utilized, including but not limited to the design and dimensions of the cartridge chamber and/or syringe. Keypad 120 and LCD display 121 are located on body 115.

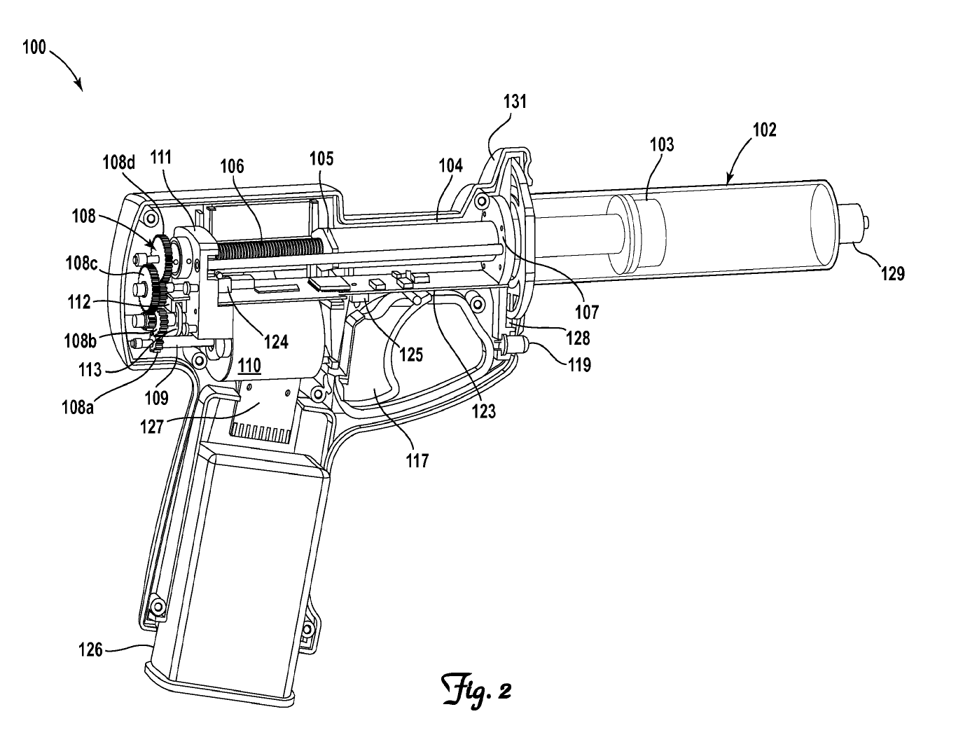

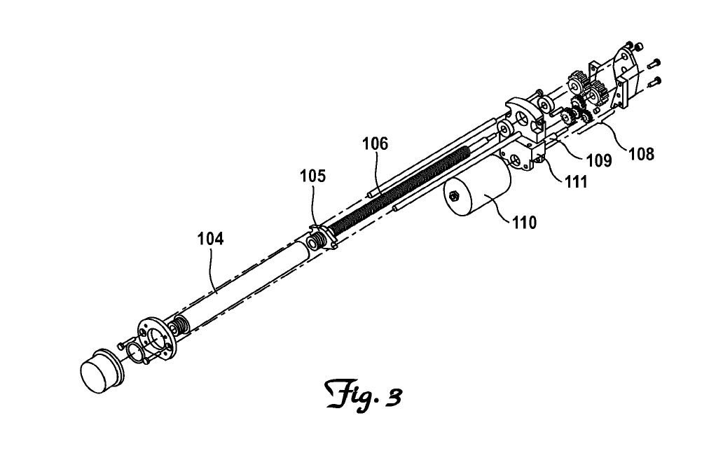

FIGS. 2 and 3 refer to the internal structure of the fluid dispenser 100. Longitudinally extending cartridge chamber or syringe 102 contains the material to be dispensed; the design of the cartridge chamber is capable of dispensing material with a large spectrum of viscosities. A 30 cc syringe or cartridge chamber is used as an example but this design is adaptable to configurations that differ from that. The length of the dispenser mechanism controls the maximum length of the syringe. The size of the slot 128 of snout 131 controls the maximum size of the flange and the syringe diameter. These two factors limit the maximum syringe size to 30 cc in this version of the design. Redesigning so that the snout and piston are interchangeable will allow for different size syringes. Since the maximum length of travel is fixed, larger syringes will need larger diameters. The interchangeable snout may have to be made from metal and software changes would also be required.

The cartridge chamber or syringe 102 receives a plunger 103, which seals the cartridge chamber, and when extended longitudinally, forces the material in the cartridge to an outlet 129 at the end of the cartridge chamber 102. The plunger 103 is mounted on piston shaft 104 that is guided by syringe plate 107 and driven by drive nut 105 located in drive enclosure 116. The extension or retraction of the plunger 103 is made in response to the operation of a longitudinally extending/retracting lead screw 106 and gear train 108. As the gear train is engaged, lead screw 106 rotates and drives the drive nut 105 either forwards for dispensing, or reverse for unloading the syringe 102. The piston shaft 104 is hollow so that the lead screw can enter it as the plunger 103 is retracted. The advantage of this arrangement is that in case of material blow-by, the lead screw 106 is protected and an O-ring (not shown) keeps the material from entering the dispensing mechanism.

Gear train 108 located in body 115, is coupled to motor mount 111 and is provided with gear 108a, driven by additional gears 108b, 108c and 108d. Gear 108a is attached to the shaft 109 of electric motor 110, which is attached to motor mount 111. As the motor 110 causes shaft 109 to rotate, gear 108a rotates and in turn causes gears 108b, 108c and 108d to rotate, thus extending or retracting the lead screw 106 longitudinally depending upon the direction of rotation of motor shaft 109. FIG. 3 illustrates the dispensing mechanism of the present invention which includes motor 110, motor mount 111, shaft 109, gear train 108, lead screw 106, drive nut 105, piston shaft 104 and plunger 103. Dual channel optical sensor 112 and encoder wheel 113 are additionally coupled to gear train 108 and together comprise the optical feedback which functions to monitor and track the fluid volume of the material being used. The dual channel optical sensor generates a quadrature pulse that also contains speed and direction information. Control circuit board 123 is located directly above the motor 110. The home position switch 124 and trigger switch 125 are mounted to the control board 123. The home position switch 124 signals the initial reference position for the dispensing mechanism and the distance moved from this position is used to calculate both the insufficient material and syringe empty statuses discussed below. Trigger switch 125 is contacted when pressure is applied to trigger 117, communicating through control board 123 to start motor 110 thus engaging gear drive 108, extending/retracting lead screw 106, which extends/retracts piston 103, which dispenses/unloads the material in cartridge chamber 102. Control board 123 controls the following major functions of the fluid dispenser such as user input, information display, mechanism control, work area illumination, power management, data collection and communication with a personal computer (PC) as discussed further below.

Battery pack 126, along with battery contact 127, are housed in handle 114 and provide the necessary power needed for the fluid dispensing system. The battery pack may utilize lithium polymer batteries and may integrate protection circuitry, charging circuitry and a fuel gauge. The inclusion of these functions allows the battery pack to be charged independently of the fluid dispenser. The protection circuitry protects the battery pack 126 from excessive current flow during charge as well as discharge. In addition, during discharge the protection circuitry protects against discharging below a safe voltage level, and during charge the protection circuitry protects against excessive voltage levels. If a fault is detected it disconnects the battery and to restore power, the fault has to be corrected and a reset has to be initiated.

The charging circuitry utilizes high frequency switching to minimize component size. It uses the constant current/constant voltage charging profile for lithium polymer batteries. If the charger detects an excessively low voltage then it starts the charge with a low trickle current. After a preset time it changes over to the normal charging current.

The state of charge of the lithium polymer battery cannot be determined from battery voltage, therefore the fuel gauge measures the total charge current. To measure the remaining charge the fuel gauge subtracts the discharge current used by the instrument. In addition, the fuel gauge compensates for self discharge, temperature and aging and reports the remaining charge as a percent (%) of full capacity. Since the fuel gauge stays with the battery, it records the charge/discharge data when outside of the instrument. Therefore this data is reported correctly when interchanging battery packs.

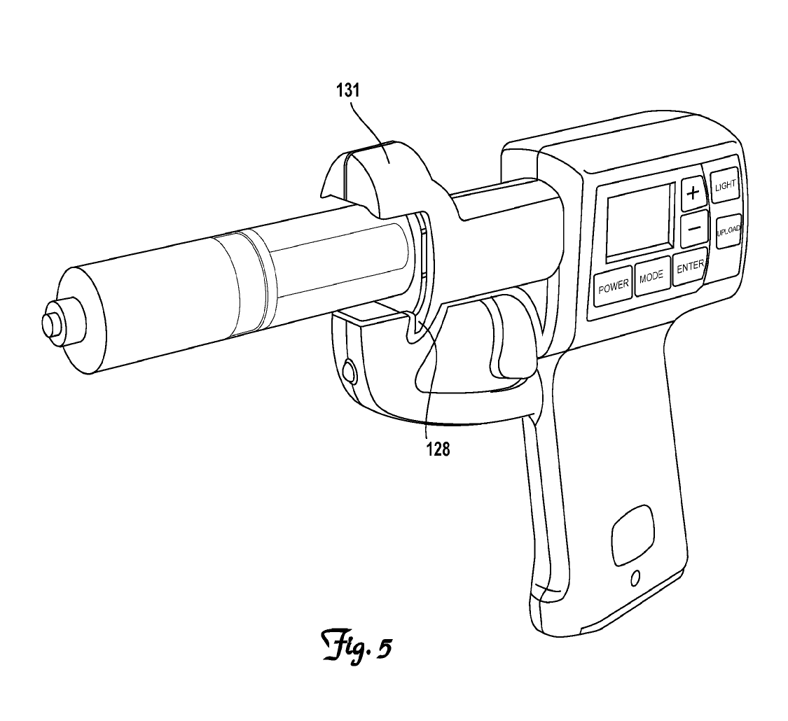

In order to operate the fluid dispenser 100, the user inserts cartridge chamber 102 which contains the desired material to be used into the slot 128 of snout 131. The cartridge chamber 102 is retained in place by friction. In order to dispense, the user turns the fluid dispenser 100 on and selects various settings and controls as desired and discussed further below. When the proper specifications have been selected for the desired material being dispensed, pressure is applied to the trigger 117 in the handle 114 which then activates a trigger switch 125 to turn on the motor 110. The motor 110 then rotates shaft 109 which engages gears 108a to 108d of gear train 108. Gear train 108 rotates lead screw 106, extending piston 103, which dispenses the material in cartridge chamber 102. When the desired amount of material has been dispensed, the motor reverses rotation, which engages the gear train and causes lead screw 106 to retract thus pulling back piston 103. This pull back releases pressure in the cartridge chamber accumulated during dispensing of the material and prohibits any remaining material from leaking out enhancing the accuracy of the fluid dispensing system. FIG. 5 illustrates an alternative embodiment of the dispenser in which the snout 131 is larger.

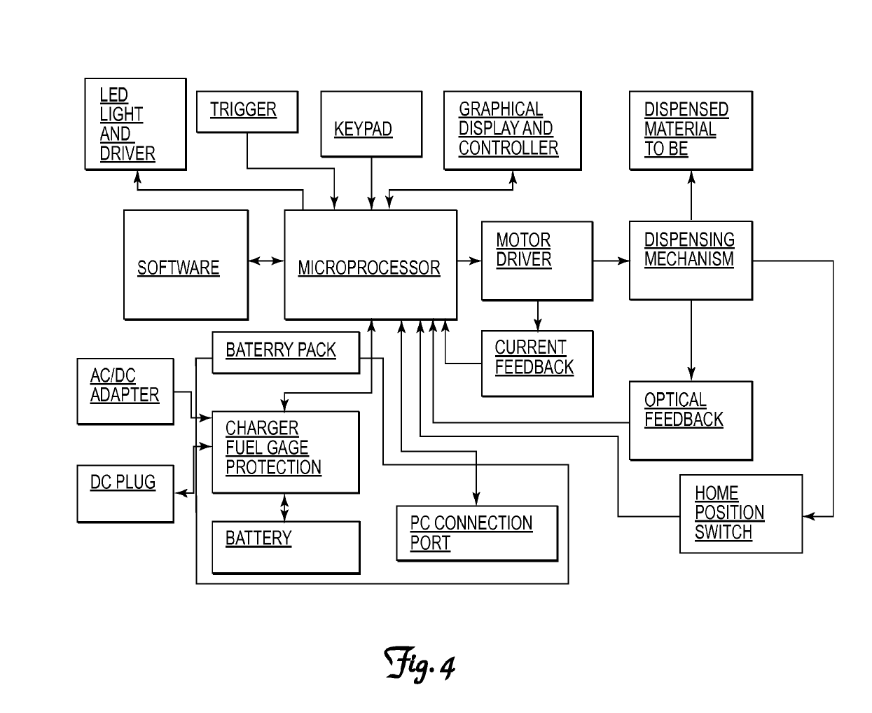

A flowchart of the fluid dispenser's system and operation of the present invention is shown in FIG. 4. A microprocessor in the control board 123 gives and collects data from the other components of fluid dispenser 100, controlling the functions of the device. The microprocessor contains flash memory that retains its information even with the power off and is divided up into functional segments. This segmentation provides for shutting down the power to individual segments and means that when it enters the sleep mode for power saving the processor can still receive signals to wake up if the trigger or the power on key is activated. The realtime clock has been moved to the battery pack so that the calendar information is not lost if the battery pack is removed. Since each battery pack contains a realtime clock when interchanging battery packs the correct date and time will always be displayed. The microprocessor also contains communication ports for the standard protocols such as USB 2.0, I2C.

A motor driver in the control board 123 consists of 4 transistors in an H bridge configuration and a current sensing resistor. Each of the transistors is individually driven by a signal from the microprocessor. The microprocessor sends the appropriate signals to drive the motor including clockwise, counter clockwise or signaling dynamic breaking for rapid stop. The current flowing through motor 110 passes through the current sensing resistor and a voltage is developed. This voltage is used by the microprocessor to ensure that the motor is not overloaded and damaged.

The software of the fluid dispenser implements the following major functions: user input, information display, mechanism control, work area illumination, power management, data collection and communication with a PC.

### User Input Function

The keypad 120 makes possible the entering of dispensing parameters as well as data gathering controls. It is scanned by the microprocessor and is then interpreted and acted upon by the software.

The power key turns power on/off. If no dispensing is taking place, after a preset time, the power is turned off and the microprocessor enters the sleep mode. Pressing the power key or pulling the trigger brings the microprocessor out of sleep mode turning the power back on.

The light key turns the LED light on/off. The “+” key increases light intensity and the “−” key decreases it.

The unload key retracts the dispensing mechanism to home position. During normal operation the home screen displays the following information: speed in cc/min; dispensing volume in 0.02 cc increments; pull back on a scale of 0-100; amount of syringe or cartridge chamber volume remaining in 0.02 cc resolution; during normal operation, when the home screen is displayed, the “+” or “−” keys will change the speed setting. Pullback retracts the piston after trigger release, to prevent material from continuing to drip caused by pressure build up in the syringe. Pulling back the piston relieves the built up pressure.

The mode key scrolls to values other than the speed to be adjusted and include the following functions: pull back, volume, display contrast and LED brightness.

Pull back can be controlled through the use of the “+” and “−” keys to adjust the pull back value from 0 for no pull back, to 100 for maximum pull back.

Volume can be controlled through the use of the “+” and “−” keys to adjust the value from 0 to a preset maximum in increments of 0.02 cc. If the volume is set to 0 then dispensing will be under manual control, meaning that as long as the trigger is pulled dispensing will continue.

Display contrast can be controlled through the use of the “+” and “−” keys to adjust the contrast value from 0 minimum to 100 maximum contrast.

LED brightness can be controlled through the use of the “+” and “−” keys to adjust the brightness value from 1 minimum to 8 maximum.

The enter key enters the value and returns the display to the home screen.

### Information Display

The choice of a graphical display provides the flexibility to adapt the fluid dispenser to a multitude of environments. The graphical display allows different languages such as English or Chinese characters to be displayed. It is also used to display dispensing data as well as instrument status. Communication with the graphical display is bidirectional.

### Mechanism Control

The mechanism control consists of the following functions: home position detection; start of fluid detection; remaining fluid volume tracking; insufficient volume detection; automatic unload; dispensing volume control; pull back control; speed control; and motor overload protection.

The home position switch 124 is mounted on the control board 123 and is activated when the drive nut 105 comes in contact with it. It then signals the microprocessor to halt the motor 110. This is the reference position for the dispensing mechanism and the distance moved from this position is used to calculate both the insufficient material and the syringe empty statuses.

Depending on the product, the syringe 102 may be filled with different volumes of fluids and the start of fluid tracking may be monitored. Additionally, the syringe may have already been used and may only be partially filled. Since it is probable that rate of flow by volume or dispensing speed is set well below the maximum value, the time to reach the start of fluid position at dispensing speed would be unacceptable. For instance, if remaining volume is 5 cc then the piston will have to travel from the home position which is 35 cc to the 5 cc position. The travel distance will be 35 cc-5 cc=30 cc. If the rate of flow by volume or dispensing speed is set to 20 cc/minute then it will take 1½ minutes to reach the 5 cc position. However if the travel is at the 150 cc/minute autoload speed the travel time will be reduced to 30/150=12 seconds. In either case it is highly desirable to reach the fluid as fast as possible. Therefore a method to detect and/or monitor the start of fluid is implemented. The software monitors the motor current while driving the mechanism at maximum speed. When the piston contacts the plunger, which is in contact with the fluid, there is an increase in the motor current. The detection of this increase in conjunction with detection of motor stall signals the microprocessor to halt the motor. The microprocessor then initiates dynamic breaking to rapidly halt the motor.

Remaining fluid volume tracking or monitoring can be utilized by means of feedback information from the dispensing mechanism providing to the software a means of precise control. The optical sensor 109 generates a dual channel quadrature pulse signal. This signal contains information for direction sensing, speed control or rate of flow by volume control, distance traveled, which translates into dispensing volume control, and material remaining in the syringe. Each pulse represents a discrete amount of dispensed material. Counting the quadrature pulses allows accurate control of the dispensing volume. Subtracting the dispensed volume from the maximum available volume for the particular fluid contained in the cartridge chamber or syringe results in the remaining volume.

When insufficient volume is detected and the remaining volume is less than the programmed dispensing volume, no dispensing will take place and a notification will be displayed on the screen.

If the maximum available volume is reached when the dispensing volume is set to manual, the mechanism automatically retracts back to the home position. When the dispenser is set to a programmed volume and the insufficient volume remaining warning is displayed the dispenser will not unload automatically. The user has to press the unload key to unload the syringe.

The user can program the volume to be dispensed. The same volume will be dispensed each time the trigger is activated. If the trigger is pulled and remains pulled, then dispensing will keep on repeating with short pauses in between until the trigger is released. Since each pulse of the quadrature signal represents a discrete volume, the counting of these pulses allows exact volume measurement. When the correct volume has been dispensed, the microprocessor dynamically breaks the motor 110 for a rapid stop.

The pull back control function is utilized because the syringe or cartridge chamber is flexible, and pressure created during dispensing causes the syringe to expand and the syringe flange to flex. If at the end of the dispensing cycle the piston is simply stopped and stayed in this position the syringe would slowly contract back to its original diameter and position. During this contraction, material would slowly ooze out of the syringe causing inaccurate dispensing. Immediately pulling the piston back after dispensing to release this pressure allows accurate dispensing termination. Syringe expansion varies with dispensing speed and material viscosity. For this reason the amount of pull back is made to be a programmable function.

The speed control or rate of flow by volume of the fluid dispenser is detected and monitored by the frequency of the quadrature signal generated by the optical feedback and is directly proportional to speed. If the speed is too low then power to the motor is increased, if it is too high then it is decreased. In this manner exact speed is maintained.

Motor current is continuously monitored by the software and thus protected from motor overload. If the current tries to increase to a value higher than the maximum allowed, the drive to the motor is reduced. In this manner, the current to the motor is kept at a safe level.

It should be noted that the data necessary for mechanism controls can be uploaded through a communication port to a PC. The data port can also be used to update the software.

### Work Area Illumination

The work area illumination is generated by a high intensity LED. The intensity is user adjustable and is controlled by pulse width modulation. It can be turned on/off by the light switch.

### Power Management

The purpose of power management is to minimize current consumption. This is accomplished by shutting down all circuits not in use after a preset idle time. It also reads the state of battery charge information from the battery pack and displays this value as a percentage of full charge.

### Data Collection

The microprocessor can record all operational data and associated dates. The end user can customize the data to be collected.

Communication with PC

If the end user chooses to collect data, the information can be uploaded by connecting to the PC port in the battery pack.

Although particular embodiments have been disclosed herein in detail, this has been done for purposes of illustration only, and is not intended to be limiting with respect to the scope of the appended claims, which follow. The physical enclosure presented in the application may not necessarily be an absolute configuration of the invention although it contains all features necessary for the described operation. In particular, it is contemplated by the inventor that various substitutions, alterations, and modifications may be made to the invention without departing from the spirit and scope of the invention as defined by the claims. For instance, the choice of materials or variations in the shape or angles at which some of the surfaces intersect are believed to be a matter of routine for a person of ordinary skill in the art with knowledge of the embodiments disclosed herein.

What is claimed is:

1. A method of dispensing a pesticidal bait comprising:
providing an electrically powered dispensing device having a dispensing mechanism for the dispensing of the pesticidal bait and a mechanism control for controlling the dispensing of the pesticidal bait;
loading a cartridge chamber containing pesticidal bait into the electrically powered dispensing device; and
dispensing the pesticidal bait from the electrically powered dispensing device by applying pressure on a trigger on the electrically powered dispensing device in communication with the dispensing mechanism and the mechanism control.

2. A method of claim 1, wherein the mechanism control allows a controlled volumetric flow rate of pesticidal bait to be dispensed by the dispensing mechanism.

3. A method of claim 1, wherein the mechanism control allows a controlled volume of pesticidal bait to be dispensed by the dispensing mechanism.

4. A method of claim 1, wherein the mechanism control has an optical feedback system that monitors the volume and volumetric flow rate of pesticidal bait in the cartridge chamber.

5. A method of claim 4, wherein when an insufficient volume of pesticidal bait in the cartridge chamber is detected, the dispensing is halted and pressure is released in the cartridge chamber.

6. A method of claim 4, wherein when a desired volume of pesticidal bait in the cartridge chamber has been dispensed at a desired volumetric rate of flow, the dispensing is halted and pressure is released in the cartridge chamber.

7. A method of claim 4, wherein the optical feedback system of the mechanism control has an optical sensor coupled to the dispensing mechanism.

8. A method of claim 1, wherein the electrically powered dispensing device is provided with a light source.

9. A method of claim 1, wherein the electrically powered dispensing device is provided with a user input control having an information display and manual controls for data entry, the user input control being in communication with the mechanism control.

10. A method of claim 1, wherein the pesticidal bait is in gel form.

11. A method of claim 1, wherein the pesticidal bait comprises a knockdown agent, toxicant, synergist, or insect growth regulator.

12. An electrically powered dispensing device for dispensing a pesticidal bait comprising:
a housing;
a dispensing mechanism for the dispensing of the pesticidal bait having a motor coupled to a shaft in communication with a gear train, the gear train driving a lead screw and drive nut that extends and retracts a plunger;
a mechanism control for controlling the dispensing of the pesticidal bait;
a cartridge chamber containing pesticidal bait; and
a trigger in communication with the dispensing mechanism and the mechanism control.

13. An electrically powered dispensing device of claim 12, wherein the mechanism control allows for a controlled volumetric flow rate of pesticidal bait to be dispensed by the dispensing mechanism.

14. An electrically powered dispensing device of claim 12, wherein the mechanism control allows for a controlled amount of pesticidal bait to be dispensed by the dispensing mechanism.

15. An electrically powered dispensing device of claim 12, wherein the mechanism control has an optical feedback system that monitors the volume and volumetric flow rate of pesticidal bait in the cartridge chamber.

16. An electrically powered dispensing device of claim 15, wherein when an insufficient volume of pesticidal bait in the cartridge chamber is detected, the dispensing is halted and pressure is released in the cartridge chamber.

17. An electrically powered dispensing device of claim 15, wherein when a desired volume of pesticidal bait in the cartridge chamber has been dispensed at a desired volumetric flow rate, the dispensing is halted and pressure is released in the cartridge chamber.

18. An electrically powered dispensing device of claim 15, wherein the optical feedback system of the mechanism control has an optical sensor coupled to the dispensing mechanism.

19. An electrically powered dispensing device of claim 11, further comprising a light source.

20. An electrically powered dispensing device of claim 11, further comprising a user input control having an information display and manual controls for data entry, the user input control being in communication with the mechanism control.

21. An electrically powered dispensing device of claim 11, wherein the pesticidal bait is in gel form.

22. An electrically powered dispensing device of claim 11, wherein the pesticidal bait comprises a knockdown agent, toxicant, synergist, or insect growth regulator.
